(19) United States
(12) Patent Application Publication
(10) Pub. No.: US 2012/0148972 A1
(43) Pub. Date: Jun. 14, 2012

(54) Low Force Orthodontic Arch Wire Having Blocks for Improved Treatment

(75) Inventor: Paul E. Lewis, Midvale, UT (US)

(73) Assignee: ULTRADENT PRODUCTS, INC., South Jordan, UT (US)

(21) Appl. No.: 13/380,124

(22) PCT Filed: Jun. 21, 2010
(86) PCT No.: PCT/US10/39316

§ 371 Date: Feb. 28, 2012

Related U.S. Application Data
(60) Provisional application No. 61/219,853, filed on Jun. 24, 2009.
(60) Provisional application No. 61/219,840, filed on Jun. 24, 2009.
(60) Provisional application No. 61/297,342, filed on Jan. 22, 2010.
(60) Provisional application No. 61/297,348, filed on Jan. 22, 2010.

(51) Int. Cl. A61C 7/28; B23P 11/00

(52) U.S. Cl. 433/10; 433/20; 433/24; 29/428

(57) ABSTRACT

Low force orthodontic arch wires (100) include a core wire (102) formed of a material having shape memory that extends along a generally curved arch wire axis between a first end (102a) and a second end (102b). The arch wire (100) further includes a plurality of bracket engagement blocks (104) disposed in spaced apart relationship along the length of the core wire (102). Each engagement block (104) is configured for placement within the slot of a corresponding orthodontic bracket with which it works to move the teeth in a desired direction. The engagement blocks (104) are advantageously enlarged relative to the core wire (102), providing for better engagement and reduced play between any given engagement block (104) and its corresponding bracket slot as compared to if the engagement blocks (104) were not present. The engagement blocks (104) may be disposed relative to the core wire (102).

### BACKGROUND OF THE INVENTION

1. The Field of the Invention

The present invention relates to arch wires for use with orthodontic brackets in correcting spacing and orientation of the teeth.

2. The Relevant Technology

Orthodontics is a specialized field of dentistry that involves the application of mechanical forces to urge poorly positioned or crooked teeth into correct alignment and orientation. Orthodontic procedures can be used for cosmetic enhancement of teeth, as well as medically necessary movement of teeth to correct overjets and/or overbites. For example, orthodontic treatment can improve the patient's occlusion, or enhanced spatial matching of corresponding teeth.

The most common form of orthodontic treatment involves the use of orthodontic brackets and wires, which together are commonly referred to as “braces.” Orthodontic brackets are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the bracket slots.

The brackets and the arch wire cooperate to guide corrective movement of the teeth into proper alignment. Typical corrective movements provided by orthodontic treatment can include torque, rotation, angulation, leveling, and other movements needed to correct the spacing and alignment of misaligned teeth. Torque refers to movement (i.e., tipping) of the tooth in a labial or lingual direction. Rotation refers to rotational movement of the tooth about the tooth's longitudinal axis. Angulation refers to angular movement of the tooth about an axis passing essentially perpendicularly through the labial tooth surface in order to bring the occlusal edge of the tooth in line with the occlusal plane Of the dental arch. Angulation therefore refers to angular movement of the tooth in a mesial-distal direction or distal-mesial direction relative to the occlusal edge of the tooth. Leveling relates to moving the occlusal edges of the teeth up or down and into proper alignment.

Arch wires typically have either a square, rectangular, or round cross-section. Square and rectangular cross-sections allow the arch wire to be used to apply a torquing force when engaged in an arch wire slot of an orthodontic bracket. Although a relatively thinner wire having a round cross-section does not allow application of torquing forces when engaged within an arch wire slot, it does provide a greater degree of flexibility and generally applies less force in use, which is more comfortable for the patient. The characteristic low force of round arch wires is due to their thinner cross-section. As such, wires having a round cross-section are often useful during the beginning stages of orthodontic treatment when the teeth are most mal-aligned. Use of a round arch wire allows for movement of teeth to correct mainly angulation, rotation and spacing of a patient's teeth with relatively light (and therefore more comfortable) forces.

Once these corrections have been achieved, a relatively thicker square or rectangular wire typically replaces the round arch wire so as to allow torquing of selected teeth to complete the treatment. In addition to being square or rectangular in cross-section, these arch wires are also thicker so as to limit any “play” of the arch wire within the slot of the bracket. Limiting this play increases the forces (as a result of increased arch wire thickness) applied by the wire and also increases engagement between the arch wire and the bracket slot. Such engagement is important in achieving the desired movement of the teeth. Because of these characteristics, in a typical orthodontic treatment a patient may typically require 6-9 different arch wires that are used progressively, beginning with relatively thin light force round arch wires and progressing towards stiffer, thicker square or rectangular arch wires.

In a typical orthodontic procedure, at least one of two types of orthodontic brackets is used: generic brackets or those having built-in prescription. Generic brackets typically have no built-in prescription with regards to affecting torque, angulation, and/or rotational corrective movements of the teeth. Instead, corrective movements of the teeth are controlled by manipulating (e.g., bending and/or twisting) the arch wire. However, correcting a patient's teeth with generic brackets and wire manipulation requires a great deal of skill and artisanship on the part of the practitioner. This has typically led to a lack of uniformity in treatment and can result in extended treatment times. As a result, patients fortunate enough to have a highly skilled orthodontist have typically ended up with straighter teeth as compared to patients with a less skilled orthodontist.

Orthodontic brackets having built-in prescription features (i.e., features affecting torque, angulation, and/or rotational corrective movements of the teeth) were developed in an effort to increase uniformity of treatment and improve patient outcomes. Orthodontic brackets having built-in prescription features are different when compared to generic brackets in that they have angled features (e.g., angled wire slots and/or angled bases) that control the direction of corrective movements. For example, a bracket designed to provide torque control may have an arch wire slot that is angled either upwardly or downwardly depending on the direction of the corrective movement that is required. To provide rotation, the slot would be rotated about the tooth's vertical axis. To provide angulation, the slot would be angled relative to the occlusal edge of the tooth.

While prescription orthodontic brackets eliminate some of the difficulties associated with generic orthodontic brackets (e.g., the need for elaborate wire bends), they create their own difficulties. For example, a manufacturer may need to make 20, 30, or more different brackets in order to fit many different tooth sizes and shapes while simultaneously providing the angled features (e.g., angled wire slots and/or angled bases) necessary to provide the corrective movements needed to correct patients' teeth. This can increase manufacturing costs and difficulty because of the need for additional tooling to make the various types of brackets.

Brackets having built-in prescription features can also complicate the process of installation by the practitioner. For example, a typical case employing 20 brackets on 20 different teeth may require the selection and attachment of as many as 17 different brackets. This increases difficulty in attaching the brackets, as there is potential for mix up, and the practitioner has to make often difficult choices in terms of bracket selection. And if the practitioner makes a mistake in bracket selection, the whole set of brackets may have to be removed from the patient's teeth and replaced. This can be expensive, time consuming, and painful for the patient.

### BRIEF SUMMARY OF THE INVENTION

The present invention is directed to low force orthodontic arch wires capable of applying torquing and/or other corrective forces early in orthodontic treatment. The low force arch wire includes a core wire formed of a material having shape memory that extends along a generally curved arch wire axis between a first end and a second end. The arch wire further includes a plurality of bracket engagement blocks disposed in spaced apart relationship along the length of the core wire. Each engagement block is configured for placement within the slot of a corresponding orthodontic bracket with which it works to move the teeth in a desired direction. The engagement blocks are advantageously enlarged relative to the core wire (i.e., the cross-sectional width of the engagement blocks is greater than the cross-sectional width of the core wire), providing for better engagement between any given engagement block and its corresponding bracket slot as compared to if the engagement blocks were not present.

In short, the enlarged engagement blocks provide for increased surface contact and engagement between the slot and arch wire than would otherwise occur if the blocks were absent. This improved engagement and reduced play of the arch wire in the bracket slot results in better application of corrective forces over a longer period of time. For example, a typical patient may visit the orthodontic practitioner about once every 6 weeks to have adjustments in the arch wire and/or brackets made. Application of corrective forces is best just after the adjustments are made. Because of play between the arch wire and bracket slot, a typical arch wire loses its ability to effectively transfer forces to the bracket and teeth as the teeth begin to move. Another adjustment is necessary. Typically, the vast majority of corrective movement occurs for only about 2 weeks after adjustment. After this point, because of play between the arch wire and bracket slots, little movement occurs. This period of time, which may be as much as about 4 weeks of a 6 week adjustment interval, is mostly wasted. Corrective movement that lasts longer than this typical 2 weeks is possible by using a larger, stiffer arch wire (which reduces play between the bracket slot and arch wire), but this is uncomfortable for the patient, and may also actually increase overall treatment time as recent studies have shown that consistent low force application actually moves the teeth faster than high forces from stiffer arch wires.

In contrast, the thin core wire portions of the arch wire advantageously result in an arch wire with relatively low stiffness, so that the arch wire applies low corrective forces to the brackets and teeth. These characteristic low forces result in decreased treatment time, as the teeth tend to move faster under application of such forces. This unique combination of low stiffness coupled with the enlarged engagement blocks allows for corrective forces to be relatively small, comfortable, and more efficient, providing excellent engagement (i.e., reduced play) between the arch wire and the bracket slots. This combination of better engagement, reduced play, and continuous low force advantageously allows for significant reduction in treatment times.

According to one embodiment, at least some of the engagement blocks will have a rectangular (e.g., square) cross-section. Some of the engagement blocks (e.g., corresponding to the rearward oriented teeth) can have a round (e.g., circular) cross-section. Rounded blocks do not provide a torque value but facilitate lateral of the bracket relative to the block owing to reduced friction between rounded engagement blocks and brackets compared to rectangular blocks.

According to one embodiment, the orthodontic wires can include similar or differently-sized interconnecting wires between different engagement blocks to promote more or less force between adjacent blocks depending on the desired treatment.

In some embodiments, the orthodontic arch wires may advantageously include built-in prescription features for providing corrective movements to misaligned teeth. In particular, the arch wire may include built-in prescription features for providing a predetermined or desired level of corrective torque, angulation, and/or rotational movement to a patient's teeth. The built-in prescription can be provided by angling some or all of engagement blocks relative to the axis of the arch wire and/or relative to each other. When the wire and engagement blocks are coupled with the brackets, the orthodontic arch wire assembly is able to move the patient's teeth in a desired way to correct misalignment of the teeth.

A corrective torque movement can be provided when at least two of the engagement blocks are rotationally offset relative to each other along the curved arch wire axis. When the rotationally offset engagement blocks are inserted into the slots of their respective brackets, the misaligned slots of the brackets on adjacent teeth wind up an intervening portion of the core wire. The wound core wire exerts corrective forces that cause one or more of the engagement blocks to rotate about the axis of the core wire, thereby applying a corresponding torquing force onto the corresponding bracket(s), which brings the teeth in the desired torque alignment as the wire unwinds.

To provide a corrective rotational movement at least one of the engagement blocks is rotated labially-lingually relative to the arch wire axis in order to provide a corrective rotational movement. When the rotationally offset engagement block is inserted into the slot of its respective bracket, the misaligned slot of the bracket on the misaligned teeth creates a bend in the core wire adjacent to the engagement block. The bent core wire exerts a corrective force on the engagement block that causes the bracket to bring the teeth into the desired rotational alignment as the wire unbends.

To provide a corrective angular movement at least one of the engagement blocks is angled gingivally-occlusally relative to the arch wire axis in order to provide a corrective angular movement. When the anglularly offset engagement block is inserted into the slot of its respective bracket, the misaligned slot of the bracket on the misaligned teeth creates a bend in the core wire adjacent to the engagement block. The bent core wire exerts a corrective force on the engagement block that causes the bracket to bring the teeth into the desired angular alignment as the wire unbends.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A is a perspective view of an exemplary low force orthodontic arch wire having bracket engagement blocks disposed along the length of the arch wire;

FIG. 1B is a cross-sectional view of the arch wire of FIG. 1A along lines 1B-1B;

FIGS. 2A and 2B illustrate an exemplary arch wire in which some of the engagement blocks are round rather than rectangular;

FIG. 3A is a perspective view of an alternative low force orthodontic arch wire having engagement blocks disposed along the length of the arch wire;

FIG. 3B is a cross-sectional view of the arch wire of FIG. 3A along lines 3B-3B;

FIGS. 4A and 4B illustrate an exemplary arch wire in which some of the engagement blocks are round rather than rectangular;

FIG. 5 illustrates an exemplary arch wire having differently-sized interconnecting wires between engagement blocks;

FIG. 6 illustrates a round engagement block having ramped rather than square ends;

FIG. 7A is a side view of an exemplary low force orthodontic arch wire in which an engagement block is engaged within a corresponding bracket, and in which there is some play between the engagement block and the bracket slot; and

FIG. 7B is a side view of an alternative exemplary low force arch wire in which an engagement block is engaged within a corresponding bracket and in which there is substantially no play between the engagement block and the bracket slot;

FIG. 7C is a side view of an alternative exemplary engagement block having a round rather than square cross-section engaged within a corresponding bracket;

FIG. 8 is a perspective view of a pair of mandibular and maxillary low force orthodontic arch wires engaged with corresponding brackets;

FIG. 9A is a perspective view of the gingival/occlusal face of a simplified arch wire assembly showing an engagement block configured for torque movement of a tooth;

FIG. 9B is a cross-sectional view of an engagement block similar to that of FIG. 2A configured for torque movement of a tooth;

FIG. 10A is a perspective view of the gingival/occlusal face of a simplified arch wire showing an engagement block configured for rotational movement of a tooth;

FIG. 10B is a view of an engagement block similar to that of FIG. 3A configured for rotational movement of a tooth;

FIG. 11A is a perspective view of the labial/buccal face of a simplified arch wire showing an engagement block configured for angulation movement of a tooth;

FIG. 11B is a view of an engagement block similar to that of FIG. 4A configured for angulation movement of a tooth;

FIG. 12A illustrates the plurality of teeth having orthodontic brackets installed thereon; and

FIG. 12B illustrates an exemplary arch wire inserted within a slot of each of the orthodontic brackets.

### DETAILED DESCRIPTION OF THE PREFERRED EMBODIMENTS

### I. Introduction and Definitions

The present invention is directed to a low force orthodontic arch wire which provides light force corrective movement to the teeth through corresponding orthodontic brackets. At the same time, the arch wire provides excellent engagement between the arch wire and the bracket slots so as to apply such light corrective forces over an extended period of time with minimal adjustment required. The arch wire includes a core wire extending along a generally curved arch wire axis between a first end and a second end, and a plurality of spaced apart bracket engagement blocks disposed along the length of the core wire. The engagement blocks are enlarged relative to the core wire so as to allow the blocks to more fully engage with the surfaces of the corresponding bracket slots.

In one embodiment, the arch wire may include built-in prescription features for providing corrective torque, angulation, and/or rotational movements to a patient's teeth. The built-in prescription can be provided by angling engagement blocks relative to the axis of the arch wire and/or relative to each other.

As used herein, the term “occlusal” refers to the biting surfaces of the teeth including teeth with “incisal” surfaces. The term can also be used directionally to refer to a direction or surface that is parallel to the biting surfaces of the teeth.

As used herein, the term “occlusal plane” refers to an imaginary plane on which the upper and lower teeth meet.

As used herein, the term “gingival” refers to the gums. The term can also be used directionally to refer to a direction or surface that is toward the gums.

As used herein the terms “occlusal” and “gingival” generally mean opposite directions when referring to a single tooth or dental arch. Nevertheless, a direction that is occlusal when referring to the upper teeth will typically be gingival when referring to the lower teeth. Likewise, a direction that is gingival when referring to the upper teeth will typically be occlusal when referring to the lower teeth.

As used herein, the term “labial” refers to the lips. The term can also be used directionally to refer to a direction or surface that is toward the lips. Labial is often used synonymously with the term “buccal.”

As used herein, the term “buccal” refers to the cheeks. The term can also be used directionally to refer to a direction or surface that is toward the cheeks. Buccal is often used synonymously with the term “labial.”

As used herein, the term “lingual” refers to the tongue. The term can also be used directionally to refer to a direction or surface that is toward the tongue.

As used herein, the term “palatal” refers to the hard palate that forms the roof of the mouth. The term can also be used directionally to refer to a direction or surface that is toward the palate.

### II. Exemplary Low Force Orthodontic Arch Wires

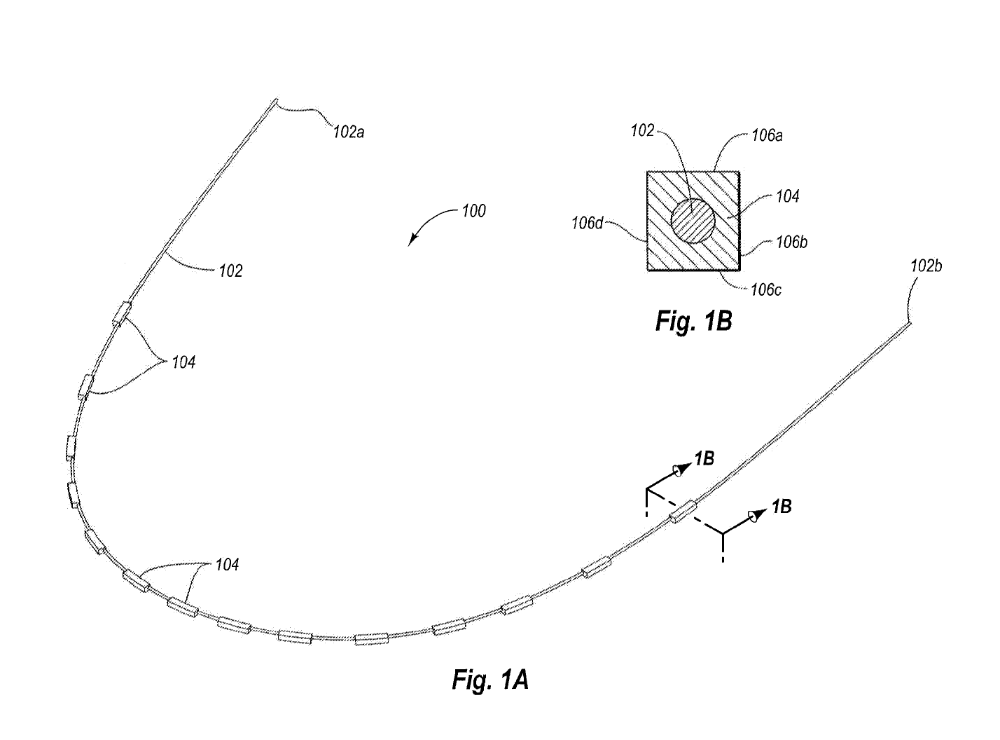

FIGS. 1A-1B illustrate an exemplary orthodontic arch wire 100 that is characterized by low force and advantageously is also capable of torque application. The orthodontic arch wire 100 includes a generally curved core wire 102 and a plurality of spaced apart engagement blocks 104 disposed along the core wire 102. Together, the core wire 102 and the engagement blocks 104 form the orthodontic arch wire 100. The engagement blocks 104 typically have a diameter that is greater than the diameter of adjacent segments of the core wire 102.

As illustrated in FIG. 1A, core wire 102 can be a single strand of wire that extends between a first end 102a and a second end 102b. Core wire 102 is preferably formed using a shape memory alloy (SMA) such as a nickel-titanium alloy. SMAs have a shape memory effect in which they can be made to remember a particular shape. Once a shape has been remembered, the SMA may be bent out of shape or deformed and then returned to its original shape by unloading from strain or heating.

Exemplary classes of SMAs are as follows: copper-zinc-aluminum; copper-aluminum-nickel; and nickel-titanium (“NiTi”) alloys (e.g., Nitinol). Cobalt-chromium-nickel alloys and cobalt-chromium-nickel-molybdenum alloys (known as Elgiloy alloys) are similar to SMAs in that they have a high modulus of elasticity and they can be used in many similar applications. However, unlike SMAs, cobalt-chromium-nickel alloys and cobalt-chromium-nickel-molybdenum can be permanently deformed without the application of heat by exceeding the modulus of elasticity. The temperatures at which SMAs and similar alloys change their crystallographic structure are dependent on the particular alloy, and can be fine tuned by varying the elemental ratios or by varying the conditions of manufacture. Although perhaps less preferred, chromium-nickel alloys and cobalt-chromium-nickel-molybdenum Elgiloy alloys are within the scope of the term “shape memory materials”, and may be used in the manufacture of the inventive arch wire.

Core wire 102 is shown as including a round (e.g., circular) cross-section of constant diameter from first end 102a to second end 102b. Although this is currently preferred, it will be understood that alternative embodiments may include a core wire of non-round cross-section, e.g., square or rectangular, or round wires of oval cross-section. In addition, the diameter may vary along the core wire length. In addition, core wire 102 can have a constant diameter or it may have a diameter that varies between different engagement blocks so as to provide a desired level of force on adjacent engagement blocks. In other words, core wire 102 may have a different diameter or thickness that varies from the first end 102a to the second end 102b, e.g., to provide different levels of twisting or bending forces along the length of the wire so as to provide a desired level of force on adjacent engagement blocks. Exemplary diameters for a round core wire 102 may range from about 0.1 mm to about 1 mm. Typical wire diameters include, but are not limited to about 0.1 mm, about 0.15 mm, about 0.2 mm, about 0.25 mm, about 0.3 mm, about 0.35 mm, about 0.4 mm, about 0.45 mm, about 0.5 mm, about 0.55 mm, about 0.6 mm, about 0.65 mm, about 0.7 mm, about 0.75 mm, about 0.8 mm, about 0.85 mm, about 0.9 mm, about 0.95 mm, and about 1 mm. Any of the foregoing values may serve as range endpoints.

As shown in FIG. 1A, engagement blocks 104 are disposed on core wire 102 in a spaced apart arrangement. Each block 104 is positioned on core wire 102 in a position corresponding to the location of an orthodontic bracket to which the block 104 corresponds. Blocks 104 have a generally rectangular or square cross-sectional shape that allows the engagement blocks 104 to exert torquing forces against the teeth via the orthodontic bracket slots. Of course, all other corrective forces (e.g., tipping and rotation) can also be applied by blocks 104. The ability of the round core wire 102 to apply torquing forces through blocks 104 is a distinct advantage over existing low force round (e.g., circular) wires. As will be discussed below, some of the engagement blocks can have a round cross-section rather than a rectangular (e.g., square) cross-section.

The engagement blocks may optionally include wing extensions (not shown) extending mesially and distally from the buccal face of the engagement block. Wing extensions may hide and cover the core wire and engagement blocks from view. For example, the extensions may be tooth colored so as to hide the core wire and engagement blocks for aesthetic purposes. Alternatively, the extensions may be brightly colored (e.g., red, blue, green, orange, purple, etc.) so as to contrast with the color of the teeth, as some patient's desire to draw attention to their braces. Furthermore, wing extensions may provide engagement with brackets even though the underlying teeth may be highly irregularly spaced apart. To the extent that one or both wing extensions do not interface with the bracket, the excess portion(s) can be snipped off as desired by the practitioner.

The diameter of core wire 102 affects the forces that are applied to the teeth, such that different diameters may be appropriate at different stages of treatment where multiple wires are used progressively through treatment. For example, the lightest wire forces using a thinner gauge wire (e.g., about 0.1 mm or about 0.15 mm) may be most appropriate at an early stage of treatment, whereas a somewhat heavier wire (e.g., about 0.25 mm or even about 0.5 mm) may be appropriate at a later stage of treatment. However, because the system allows for full or nearly full engagement between the bracket slot and the arch wire (as a result of the enlarged engagement blocks), it may be possible to complete treatment or nearly complete treatment with only a single low force arch wire including a core wire of thin cross-section. This ability of the low force arch wire 100 to provide full or nearly full engagement with the bracket slot by means of the engagement blocks 104 is another distinct advantage over existing low force round wires.

For example, it may be possible to use a single low force arch wire throughout the entire treatment that includes a core wire cross-section that is not greater than about 0.25 mm, and more preferably that is between about 0.1 mm and about 0.2 mm. Normally it is not possible to use such a thin wire and achieve satisfactory results because such a wire is round and incapable of applying torquing forces, and because such a thin wire results in significant play between the bracket slot (which typically measures either 0.018 inch or 0.022 inch in width). The presence of engagement blocks 104 reduces or eliminates play between the bracket slot and arch wire, all while providing the arch wire 100 with low force characteristics as a result of thin core wire 102.

FIG. 1B illustrates a cross-sectional view of the orthodontic arch wire 100 of FIG. 1A along lines 1B-1B. In particular, FIG. 1B illustrates a cross-sectional view of core wire 102 and an engagement block 104. The exemplary engagement block 104 illustrated in FIG. 1B has a generally square cross-sectional profile with the core wire 102 running through the center. One will appreciate, however, that other shapes (e.g., rectangular or round) for engagement block 104 are possible and that the core wire 102 does not necessarily need to run through the center of the engagement block 104. The illustrated example of engagement block 104 includes four faces 106a-106d. Faces 106a and 106c are gingival/occlusal faces, 106b is a buccal face, and 106d is a lingual face.

The width of engagement block 104 may be sized to substantially fill the width of a typical bracket slot (e g., 0.018 inch or 0.022 inch). Such an engagement block width will reduce or eliminate play between the block 104 and the corresponding bracket slot. The enlarged characteristic of block 104 relative to core wire 102 allows core wire 102 to be relatively thin, which provides the arch wire with low force characteristics. At the same time, the enlarged block 104 is able to engage fully or nearly so within the corresponding bracket slot, reducing play between the arch wire 100 and each bracket.

This provides the advantages of a thin round low force arch wire and a thick stiff finishing arch wire within the same arch wire. Advantageously, the inventive arch wire can be used early in treatment to provide early torque correction. In addition, because the wire is low force it is more comfortable for the patient throughout the entirety of treatment, as there is no need to use a relatively thick square or rectangular finishing wire. Furthermore, because the enlarged engagement blocks provide improved engagement between the arch wire and bracket slots, play in the system is reduced. Reduced play results in corrective forces being applied more uniformly over time periods between orthodontist visits when adjustments are made. Such uniformity may result in significantly reduced overall treatment times. For example, when using typical arch wires, because of the play within the system corrective forces may no longer be appreciable about 2 weeks after orthodontist adjustment. Because typical orthodontist visits are about 6 weeks apart, this represents wasted treatment time. The inventive arch wire comfortably applies corrective forces over substantially the entire 6 week interval, significantly speeding up treatment.

Treatment times are further reduced because of the reduction or elimination of the use of relatively thick, stiff rectangular or square finishing arch wires. Recent research has shown that the teeth actually move faster under the influence of light forces as compared to stronger forces. Because the inventive low force arch wire is able to provide the needed torquing forces and full or nearly full engagement between the bracket slot and arch wire with a low force arch wire, it is not necessary to use traditional stiff square or rectangular finishing arch wires.

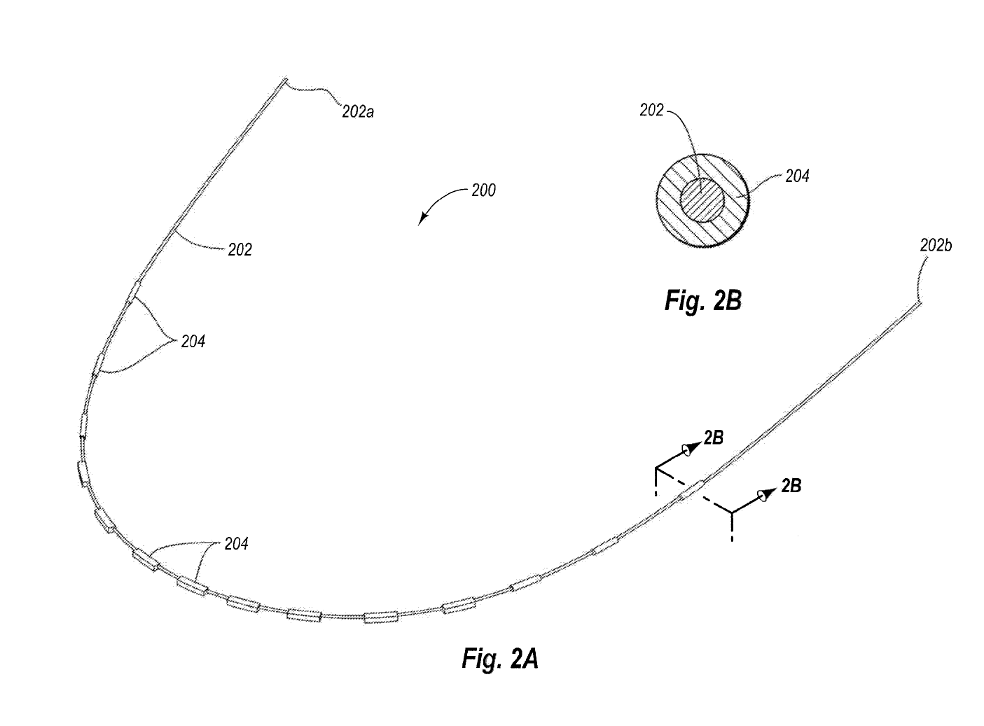

FIGS. 2A and 2B illustrate an exemplary arch wire assembly 200 in which some of the engagement blocks 204 are round rather than square or rectangular in cross-section. Round engagement blocks do not provide torque control. However, teeth positioned toward the rear of a person's dental arch typically require little or no torque control to provide proper alignment. Engagement blocks that are round may provide for desired alignment while permitting greater movement of the teeth relative to the engagement blocks since round engagement blocks create less friction with orthodontic brackets compared to square or rectangular engagement blocks.

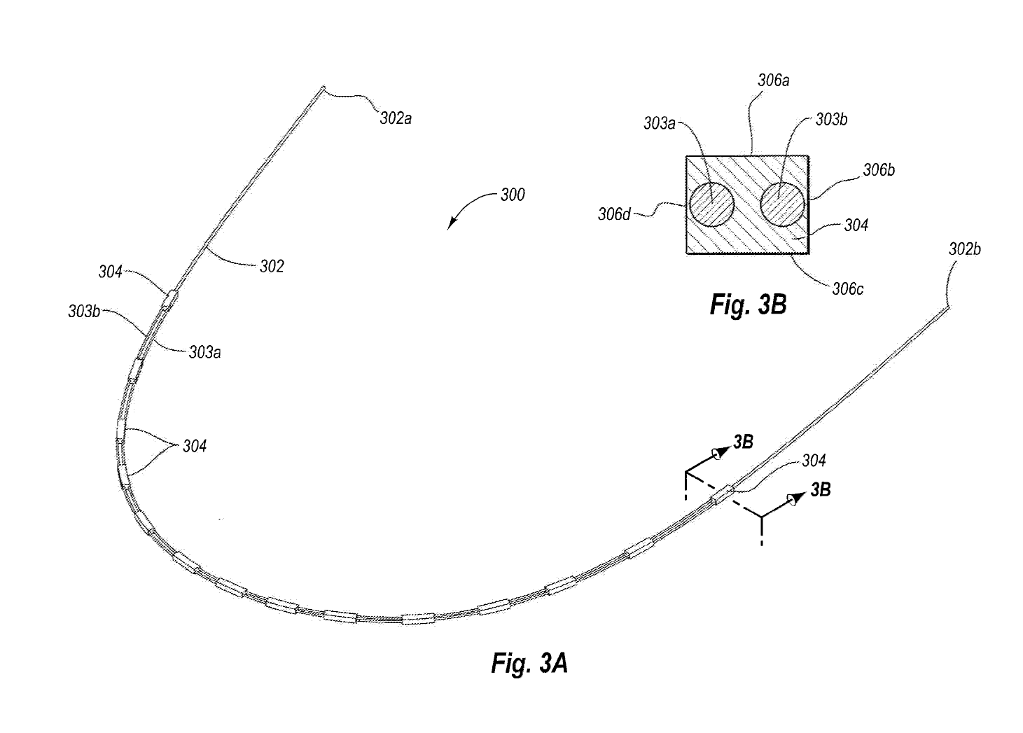

FIGS. 3A-3B illustrate an alternative orthodontic arch wire 300. The orthodontic arch wire 300 shown in FIGS. 3A-3B is similar to arch wire 100 illustrated in FIGS. 1A and 1B, except that engagement blocks 304 are coupled to a single-stranded core wire 302 at the first and second ends 302a and 302b and by dual core wires 303a and 303b throughout a central portion of arch wire 300. In other words, the portion of the arch wire 300 including engagement blocks 304 includes the two core wires 303a and 303b. In addition, engagement blocks 304 may be generally shorter than those of FIGS. 1A and 1B.

Arch wires 303a and 303b may be the same diameter or different diameters. Exemplary diameters for core wires 303a and 303b range from about 0.05 mm to about 1 mm, more preferably from about 0.05 mm to about 0.5 mm. Such an embodiment provides a mechanism for increasing the stiffness of the arch wire 300 without necessarily increasing the diameter of either core wire. It also would allow use of very small thickness wires (e.g., two 0.05 mm diameter wires). Such a small thickness single core wire may not provide sufficient force or be so thin as to not have sufficient strength for use in orthodontic treatment. Embodiments which include two core wires exhibit a stiffness and moment of inertia that is significantly less than a similarly sized rectangular wire. The moment of inertia of the arch wire's cross-sectional area is a measurement of the wire's ability to resist bending. The larger the moment of inertia, the less the wire will bend when exposed to a given force (i.e., it will be stiffer). For example, an embodiment including a first core wire (e.g., 303a) having a diameter of about 0.3 mm and a second core wire (e.g., 303b) having a diameter of about 0.4 mm will exhibit less stiffness and a lower moment of inertia than an embodiment including two core wires having diameters of about 0.4 mm. Both will exhibit lower stiffness and moment of inertia than a rectangular arch wire measuring about 0.4 mm in one dimension and about 0.8 mm in the other dimension.

As shown in FIGS. 3A-3B, the engagement blocks 304 disposed on the core wires 303a and 303b are shown as having a generally rectangular shape that allows the engagement blocks 304 to exert forces (e.g., torquing forces) against the teeth via the orthodontic bracket slots. Similar to block 104, engagement block 304 has four faces 306a-306d. Faces 306a and 306c are gingival/occlusal faces, 306b is a buccal face, and 306d is a lingual face. Although illustrated as spaced apart from one another, it will be understood that dual core wires 303a and 303b may contact one another. The selected spacing (if any) between core wires 303a and 303b may affect the stiffness of the arch wire 300.

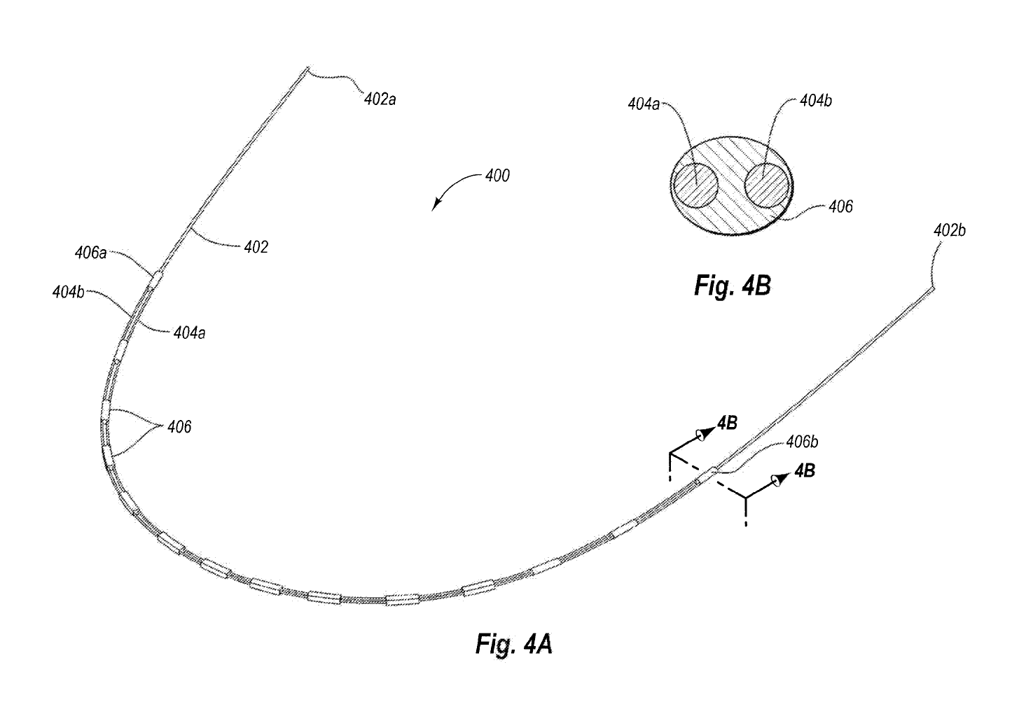

FIGS. 4A and 4B depict an exemplary arch wire 400 that is similar to arch wire 300 shown in FIGS. 3A and 3B, except that the last three engagement blocks have a round cross-section rather than square or rectangular cross-section. As discussed above, it is typically unnecessary to provide torque control to the more rearward oriented teeth, such as a person's molars. Providing engagement blocks with a round cross-section provides desired alignment such as angulation and rotation but not torque control. It will be appreciated that other engagement blocks along the length of an arch wire can be round rather than square or rectangular to the extent that torque control is not desired or required.

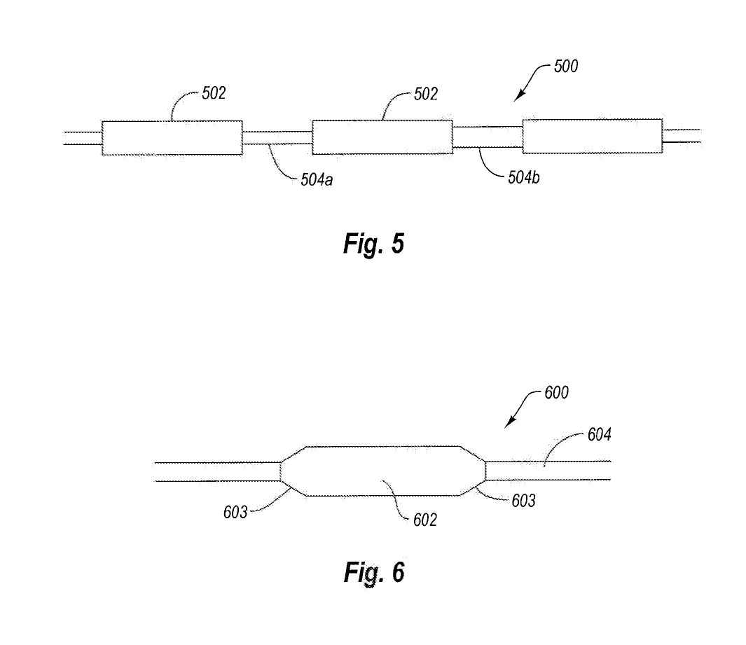

FIG. 5 illustrates a portion of an orthodontic arch wire 500, which includes engagement blocks 502 separated by a differently-sized interconnecting wires 504a and 504b. Differently-sized interconnecting wires may be advantageous where it is desired that the engagement blocks provide varying levels of force on to the brackets. For example, where a tooth is greatly misaligned, it may be desirable to provide greater force compared to a tooth that is better aligned initially.

FIG. 6 illustrates a portion of an orthodontic arch wire 600 that includes an engagement block 602 and interconnecting wires 604. Rather than having a sharp (e.g., square) edge, as in the arch wires of proceeding embodiments, the engagement block 602 includes ramped surfaces 603 that provide a more gradual transition between engagement block 602 and interconnecting wires 604. Providing a more gradual transition between an engagement block and interconnecting wires can provide greater comfort to the wearer by smoothing out otherwise sharp edges. Ramped transition surfaces can be used in round as well as rectangular or square brackets.

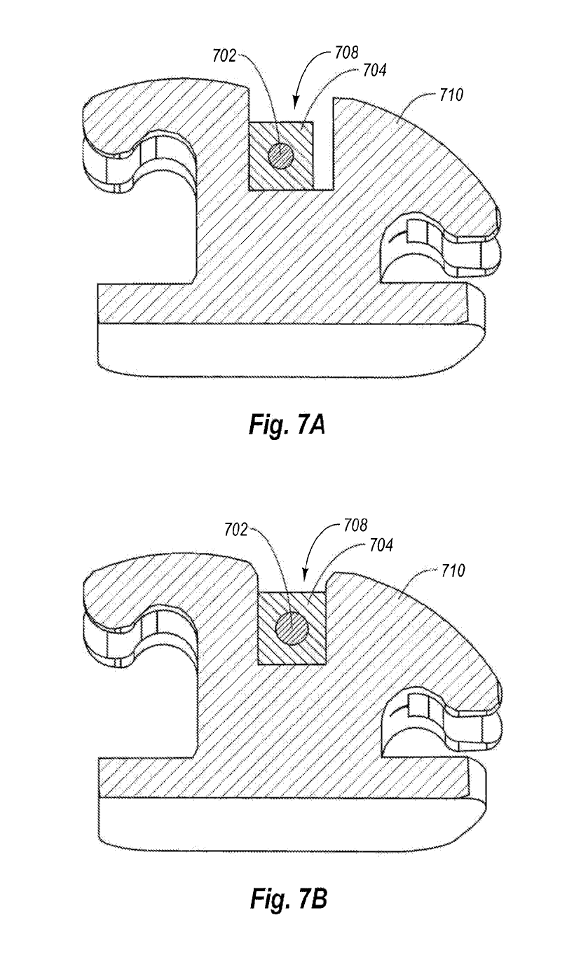

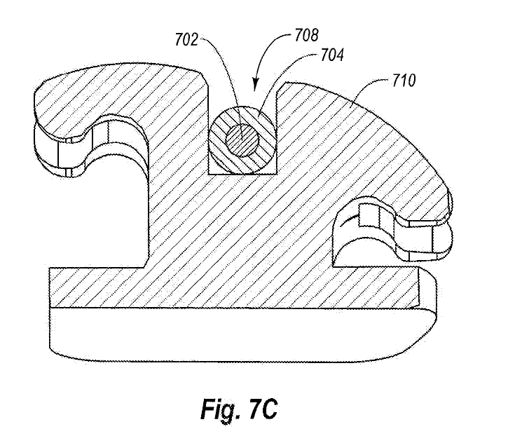

FIGS. 7A-7C illustrate cross-sectional views through exemplary brackets illustrating the reduction in play achieved by the inventive low force orthodontic arch wire. FIG. 7A shows an embodiment in which engagement block 704 is received within the arch wire slot 708 of corresponding orthodontic bracket 710. As shown, engagement block 704 is enlarged relative to core wire 702 so that play between block 704 and bracket slot 708 is reduced as compared to engagement that would otherwise be provided only by core wire 702 within bracket slot 708 if engagement block 704 were not present.

FIG. 7B illustrates a similar view, but in which the lingual-buccal play between slot 708 and engagement block 704 has been eliminated. The degree of play present between slot 708 and block 704 will depend on the dimensions of block 704 relative to slot 708. In addition, the diameter of core wire 702 is greater in the embodiment of FIG. 7B as compared to 7A. The arch wire of FIG. 7B will exhibit greater stiffness relative to the arch wire of FIG. 7A.

FIG. 7C illustrates a cross-sectional view through an exemplary bracket 710 in which an arch wire 704 having a round cross-section is introduced into arch wire slot 708. The main difference between the embodiment of 7C and those shown in 7A and 7B is that the arch wire having a round cross-section does not provide torque control. An advantage of providing an arch wire engagement block having a round cross-section is that it reduces friction between the engagement block and the bracket, which increases the ability of the bracket to move relative to the round engagement block as compared to a rectangular or square engagement block.

In practice, a practitioner may use an inventive arch wire similar to that shown in FIG. 7A or 7C early in treatment. During a later stage of treatment the arch wire may be replaced with one similar to that shown in FIG. 7B, which will provide maximum engagement with bracket slot 708, with slightly greater stiffness. The stiffness of the arch wire shown in FIG. 7B will still be significantly less than a traditional square or rectangular finishing arch wire. Alternatively, a low force arch wire as seen in FIG. 7A, 7B or 7C may be used for the entire duration of the orthodontic treatment, as it provides low force as a result of the thin diameter of core wire 702, but provides for excellent slot engagement as a result of engagement block 704. Such a configuration advantageously reduces or may even eliminate the need to use progressively stiffer arch wires during orthodontic treatment (i.e., a single arch wire may suffice).

Although described in the context of typical orthodontic bracket slots that typically have a lingual-buccal width of either 0.022 inch (0.56 mm) or 0.018 inch (0.46 mm) and a gingival-occlusal height of 0.028 (0.70 mm) inch or 0.031 inch (0.79 mm), it will be understood that the dimensions of the low force orthodontic arch wire components (e.g., the core wire(s) and the engagement blocks) may be adapted to suit any other orthodontic bracket system.

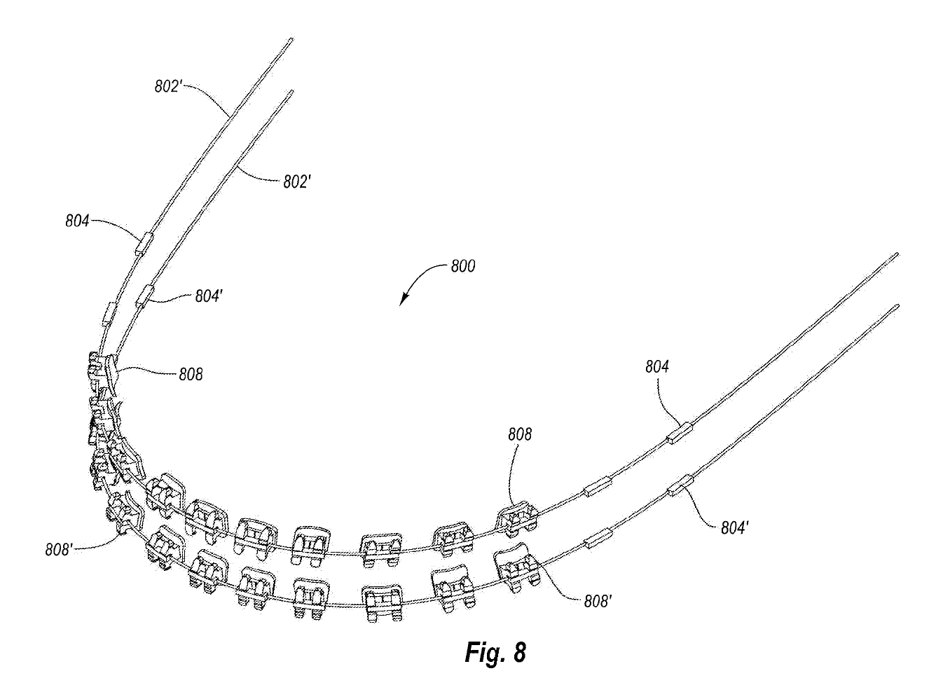

FIG. 8 illustrates a pair of arch wires 800 configured for placement on an upper/mandibular dental arch and a lower/maxillary dental arch. The upper wire 802 includes a plurality of spaced apart, enlarged engagement blocks 804, which are coupled to a partial set of orthodontic brackets 808. The lower wire 802′ includes a plurality of spaced apart, enlarged engagement blocks 804′, which are coupled to a partial set of orthodontic brackets 808′. Each coupled engagement block is coupled to its corresponding bracket.

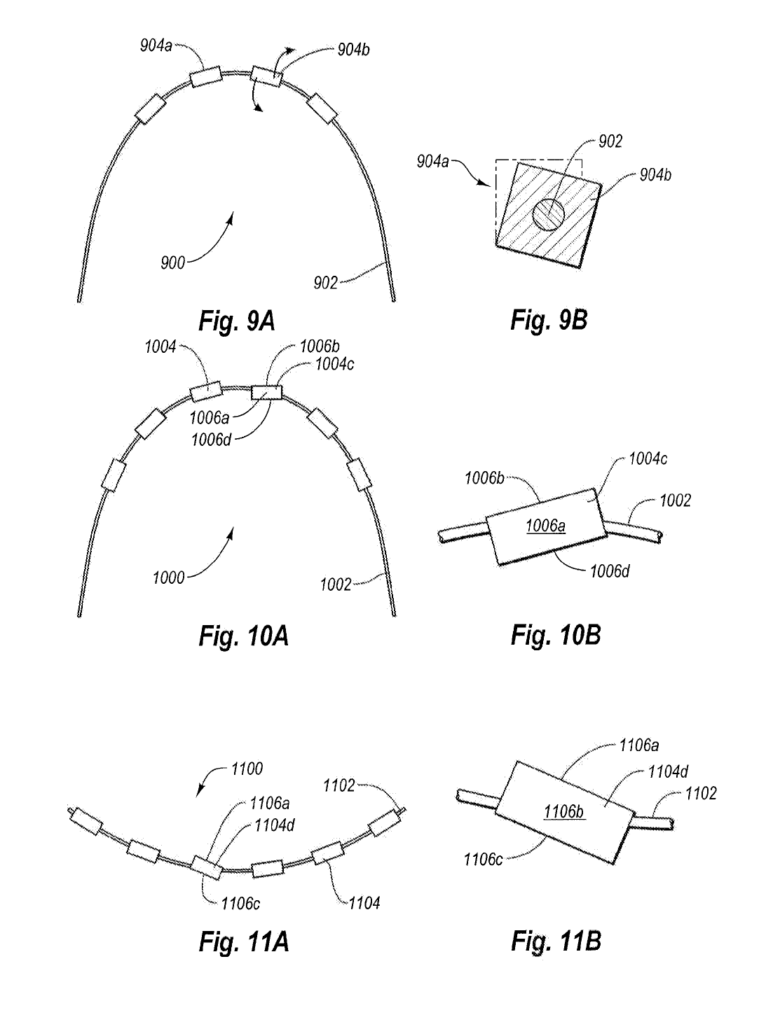

Orthodontic prescription values may be built into the brackets 808, such that the engagement blocks of the arch wire are aligned relative to core wire 802 so that the blocks provide no torque, rotation, or angulation prescription values. Rather, these prescription values are built into the bracket slots. Alternatively, the prescription values may be built into the engagement blocks 804 and 804′ so that the arch wire may be used with a set of “zero angle” brackets, in which the brackets include no torque, rotation, or angulation values. A combination system is also possible, in which the torque, rotation, and angulation values of the prescription are shared between the engagement blocks and brackets. Exemplary prescriptions that may be built into the brackets and/or arch wire include MBT, Roth, Bioprogressive/Hilgers, or combinations thereof. Further examples of engagement blocks including built-in prescription values are described in further detail below in conjunction with FIGS. 9A-11B. Such features are also described in U.S. patent application Ser. Nos. 61/219,840 and 61/297,348, both entitled “ORTHODONTIC ARCH WIRE HAVING BUILT IN PRESCRIPTION FEATURES”, filed Jun. 24, 2009 and Jan. 22, 2010, respectively. Both of the above are herein incorporated by specific reference.

The inventive low force orthodontic arch wires may be manufactured by any of various methods. For example, manufacture may be accomplished by bonding separately molded or machined engagement blocks to one or more core wires. In another embodiment, the low force orthodontic arch wires may formed through molding the arch wire so as to include engagement blocks. In one example, injection molding with metal (e.g., LIQUID METAL ALLOY) can be used to form (i.e., mold) appropriately positioned engagement blocks onto one or more previously formed core wires that are run through the mold as a secondary operation. In another method, injection molding can be used to integrally mold the core wire(s) having appropriately positioned engagement blocks connected by molded “wire” sections. In other words, the core wire and engagement blocks are molded together as a single integral piece in a single molding step. In such an embodiment, the engagement blocks may be molded having lingual-buccal width dimensions (e.g., about 0.022 inch or about 0.018 inch) configured for insertion into an orthodontic bracket slot. The molded interconnecting core wire sections are molded so as to have smaller, wire-like dimensions (e.g., preferably about 0.1 mm to about 0.25 mm).

Additional discussion of injection molding orthodontic apparatuses with liquid metal alloys can be found in PCT Patent Application Serial No. PCT/US2009/048701 entitled “ORTHODONTIC BRACKETS HAVING BENDABLE OR FLEXIBLE MEMBER FORMED FROM AMORPHOUS METALLIC ALLOYS” filed Jun. 25, 2009 and PCT Patent Application Serial No. PCT/US2009/48711 entitled “MOLD ASSEMBLY APPARATUS AND METHOD FOR MOLDING NEW ARTICLES” filed Jun. 25, 2009, each of which is incorporated herein by specific reference.

In another exemplary method, the engagement blocks and the core wire sections can be formed from a single piece of metal, such as a billet. The billet of metal (e.g., initially a rectangular metal bar) can be formed by drawing, extrusion, injection molding, or another technique known in the art. In one embodiment, engagement blocks and core wire sections can be formed from a billet of metal using a machining process, such as micromachining or electrical discharge machining, and/or a chemical etching process to remove metal from the billet so as to shape and form the engagement blocks and core wire.

Manufacturing an arch wire from a billet of metal can ease manufacture. For example, basic core wires can be machined from a straight or substantially straight billet of metal and the arch wire then can be placed into a mold or jig where it is bent into its final shape, and then the arch wire is heat set so as to retain the shape and any optional prescription values built-in to the engagement blocks. In yet another method of manufacture, the arch wire including the engagement blocks may be built up much like a silicon chip is formed using a microfabrication process. The EFAB® process developed by Microfabrica, Inc. of Van Nuys, Calif. is one example of a microfabrication process that can be employed. EFAB® microfabrication technology can be used to create complex, three-dimensional, micron-precision metal structures with unprecedented design flexibility. In the EFAB® process, a ceramic substrate is plated over by laying down a first metal material followed by subsequent layers of a second metal material. The first metal material and the second metal material can be any of a variety of materials which may be electrodeposited or depositable in some other manner. Examples of metals that may comprise the first layer include nickel, copper, silver, gold, nickel-phosphorous, nickel-cobalt, and alloys thereof. Similarly, the second metal material may take a variety of forms (e.g., copper, zinc, tin, and alloys thereof). In some manufacturing methods the first metal material is or includes nickel and the second metal material is or includes copper. The layers are built up much like semiconductor chip manufacture to create desired structures by depositing alternating layers of the second metal material with layers of a mask material. For example, the EFAB® process can be used to build up layers that define the core wire and the engagement blocks having the desired size and any optional built-in prescription features.

Additional discussion of the EFAB® process can be found in U.S. Pat. No. 6,027,630 entitled “METHOD FOR ELECTROCHEMICAL FABRICATION” and U.S. Pat. No. 7,384,530 entitled “METHODS FOR ELECTROCHEMICALLY FABRICATING MULTI-LAYER STRUCTURES INCLUDING REGIONS INCORPORATING MASKLESS, PATTERNED, MULTIPLE LAYER THICKNESS DEPOSITIONS OF SELECTED MATERIALS,” each of which is incorporated herein by specific reference.

The arch wires may be used and/or sized for use with any bracket slot, including, but not limited to typical slots measuring either about 0.018 inch (0.45 mm) or about 0.022 inch (0.55 mm) in the occlusal-gingival width direction and about 0.028 inch (0.7 mm) to about 0.031 inch (0.8 mm) in the labial-lingual depth direction. Although these slot sizes are typical, the inventive arch wires may alternatively be used with other sized slots.

Referring now to FIGS. 9A-9B, an exemplary arch wire 900 is schematically shown having an engagement block 904b that is angularly rotated about the axis of the core wire 902 to provide torque. As shown in FIG. 9B, engagement block 904b is angled or rotated on the arch 902 axis relative to engagement block 904a. Engagement block 904b is rotated either palatally/lingually or labially/buccally depending on whether positive or negative root torque is desired. Torque engagement blocks such as 904b are typically rotated in the direction where the tooth will be moved in order to set the final, correct alignment of the tooth. In the example shown in FIG. 9B, engagement block 904b is capable of torquing a tooth either lingually (i.e., inwardly) or labially/buccally (i.e., outwardly) depending on whether the arch wire is engaged with the upper/mandibular teeth or the lower/maxillary teeth.

Referring now to FIGS. 10A-10B, an exemplary arch wire 1000 is schematically shown having an engagement block 1004c that is configured to provide rotation. As shown in FIGS. 10A-10B, engagement block 1004c is rotated relative to the arch wire 1002 either clockwise or counter-clockwise depending on whether clockwise or counter-clockwise rotation of the tooth relative to the tooth's axis is desired. With further reference to FIG. 10B, face 1006a of engagement block 1004c is not tilted relative to the arch wire 1002, nor is it tilted relative to the other blocks (e.g., 1004). In contrast, faces 1006b and 1006d are angled lingually/buccally such that block 1004c is rotated either clockwise or counter-clockwise relative to the arch wire 1002 about an axis normal to face 1006a. As with torque engagement blocks, rotation engagement blocks (e.g., 1004c) are typically rotated in the direction where the tooth will be moved in order to set the final, correct rotational alignment of the tooth.

Referring now to FIGS. 11A-11B, an exemplary arch wire 1100 is schematically shown having an engagement block 1104d that is configured to provide angulation. As shown in FIGS. 11A-11B, the gingival and/or occlusal faces (1106a and 1106c) of engagement block 1104d are angularly tilted relative to the arch wire 1102 either clockwise or counter-clockwise depending on whether clockwise or counter-clockwise angulation of the tooth relative to its buccal face is desired. With further reference to FIG. 11B, buccal face 1106b of engagement block 1104d remains parallel to the arch wire (i.e., it is not tilted relative to the arch wire 1102, nor is it tilted relative to the other blocks (e.g., 1104)). In contrast, faces 1106a and 1106c are angled gingivally/occlusally such that block 1104d is rotated either clockwise or counter-clockwise relative to the arch wire 1102 about an axis normal to face 1106b. As with torque and rotation engagement blocks, angulation engagement blocks (e.g., 1104d) are typically rotated toward the direction where the tooth will be moved in order to set the final, correct alignment of the tooth.

While FIGS. 9A-11B illustrate engagement blocks that are configured to provide one type of movement (i.e., torque, rotation, or angulation), one will appreciate that blocks can be configured to provide more than one type of corrective movement at a time. For example, blocks can be configured to provide torque and angulation simultaneously, torque and rotation simultaneously, or rotation and angulation simultaneously. Alternatively, blocks can be configured that provide all three movements simultaneously. Regardless of prescription, engagement blocks can provide leveling in order to correct the height of occlusal edges of a person's teeth.

In one embodiment, a kit of wires can progressively provide the overall prescription (i.e., one or more of the orthodontic arch wires may only include a portion of an overall prescription in order for each wire to move the teeth part of the way, with the whole kit of wires required to move the teeth all of the way). Such a configuration can be advantageous, however, because it can allow the most misaligned teeth to be corrected during an early stage of treatment with lighter and more comfortable forces while movements requiring greater force or more anchoring from adjacent teeth can be accomplished at later stages of treatment. Similarly, in one embodiment the kit can include arch wires configured to provide different levels of force during different stages of treatment. For example, depending on the corrective movements needed at different stages of treatment, the kit can include wires having a gauge (e.g., a lighter gauge) selected for an early stage of treatment and a gauge (e.g., a heavier gauge) selected for a later stage of treatment.

In one embodiment, a kit can include arch wires that are configured for placement on the mandibular dental arch or the maxillary dental arch. For example, the kit can include mandibular arch wires having different sizes and shapes and/or maxillary arch wires having different sizes and shapes to account for variability in the size and shape of the maxillary and mandibular dental arches from person to person. For example, a child's dental arch is significantly shorter, with closer spacing of the teeth (and thus engagement blocks) than an adult's dental arch.

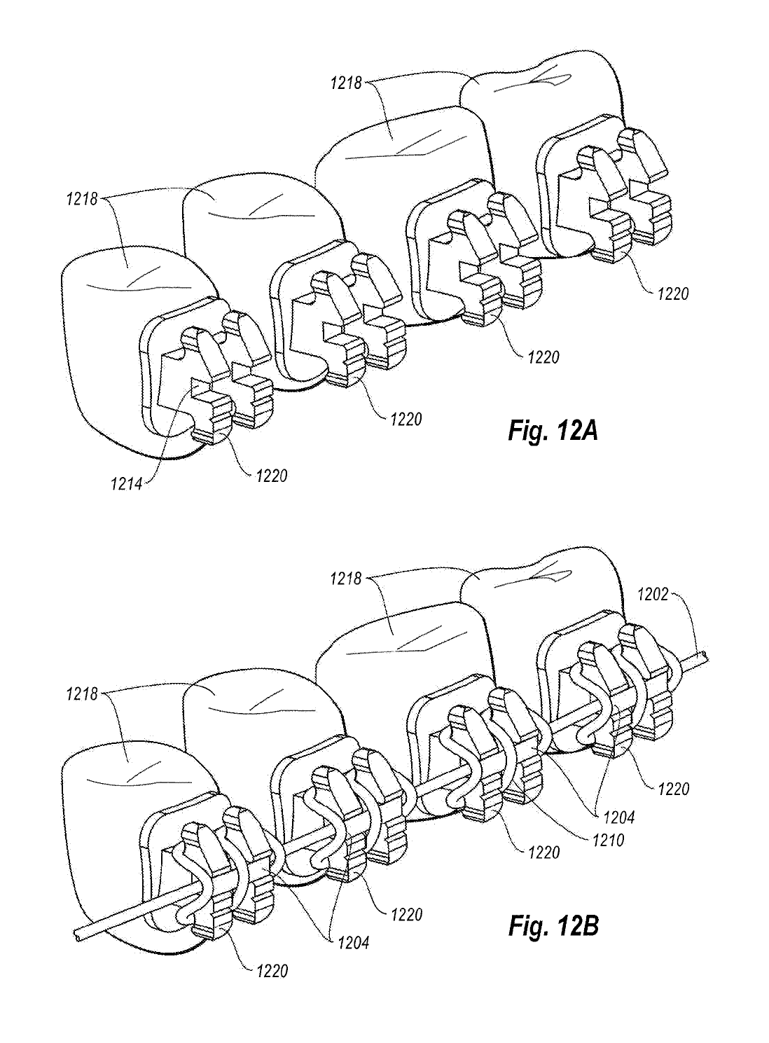

FIGS. 12A and 12B illustrate an exemplary method of using the inventive low force arch wires according to the invention. FIG. 12A shows a plurality of teeth 1218 to which orthodontic brackets 1220 have been bonded. As illustrated, the orthodontic brackets 1220 are twin brackets. However, it is to be understood that any type of orthodontic bracket or combination of brackets (e.g., nonself-ligating and/or self-ligating) may be used with the inventive low force arch wires, which may optionally include built-in prescription features.

As shown in FIG. 12B, an appropriate orthodontic arch wire 1202 having engagement blocks 1204 is selected by the practitioner and inserted into the arch wire slots 1214 of brackets 1220. Thereafter, the practitioner attaches an appropriate ligature 1210 over each bracket 1220 so as to retain the arch wire 1202 and the engagement blocks 1204 within the bracket slots 1214. According to one embodiment, the arch wire 1202 has shape memory and at least some of the engagement blocks 1204 may include a built-in prescription. In such a case, it may not be necessary for the practitioner to do anything additional at this stage. If necessary, at a later stage of treatment and to refine the prescription, the ligatures 1210 can be removed and a different wire can be inserted. Alternatively, the arch wire 1202 and engagement blocks 1204 may not have a built-in prescription so that one or more bends may be applied to the arch wire 1202, or the brackets may be configured to provide the needed corrective movement, as desired.

### III. Examples of Orthodontic Prescriptions

Orthodontic prescriptions, as embodied in the arrangement of engagement blocks disposed on the orthodontic arch wires described herein, are based on one or more idealized models of the positioning of the teeth in the mandibular and maxillary dental arches. A given orthodontic prescription is based on the torque, angulation, and rotational values that are desired for the final correctly aligned positioning of the teeth and not on the misaligned positions of the teeth at the beginning of treatment.

Presented below are three common orthodontic prescriptions—MBT, Roth, and Bioprogressive (Hilgers). Additional prescriptions known in the art, or a custom prescription provided for a specific patient could also be built into the engagement blocks of the arch wires. The engagement blocks that are included in the arch wires described herein can be configured so as to simultaneously provide the prescribed torque, rotation, and angulation values in an orthodontic prescription. The engagement blocks included in an arch wire can also be configured to provide a subset of torque, rotation, and angulation values in an orthodontic prescription. For example, arch wires can be configured with engagement blocks that provide only the torque values in a given prescription to a patient's teeth. In another example, arch wires can be provided with engagement blocks that provide at least two types of prescribed corrective movements to a patient's teeth simultaneously. In yet another example, arch wires can be provided with engagement blocks that provide prescribed torque values to some teeth while providing prescribed angulation values to other teeth. Other variations will be apparent to one of skill in the art.

In the prescriptions presented below, torque angles are measured relative to an imaginary reference line that is perpendicular to the occlusal plane (i.e., the reference line is perpendicular to the biting surfaces of the teeth). Torque angles typically refer to the “in” or “out” angling of the root. Positive torque values refer to positioning of the root in the palatal/lingual direction. Negative torque values refer to positioning of the root in the labial/buccal direction.

In the prescriptions presented below, angulation values are also measured relative to the imaginary reference line that is perpendicular to the occlusal plane (i.e., the reference line is perpendicular to the biting surfaces of the teeth). Positive angulation values typically refer to the angling or tipping of the root in the distal direction (i.e., the root is tipped away from the midline of the dental arch). However, the reference for crown tip in the upper molars is the buccal groove. This buccal groove shows about a 5° angulation to a line drawn perpendicular to the occlusal plane. Although none are listed here, negative angulation values refer to the angling or tipping of the root in the mesial direction (i.e., the root is tipped toward the midline of the dental arch).

In the prescriptions presented below, rotation describes rotation of the tooth about the vertical axis of the tooth. For example, rotation values in the prescriptions below can describe rotational angles of the buccal surfaces of the teeth relative to the arch wire axis.

### EXAMPLE 1

MBT Prescription

MBT

| Tooth | | torque | angulation | rotation |
|---|---|---|---|---|
| Uppers | central | 22° | 4° | |
| (Mandibular) | lateral | 10° | 8° | |
| | cuspid | 0° | 8° | |
| | 1st and 2nd bicuspids | −7° | 0° | |
| | 1st molar | −14° | — | 10° |
| | 2nd molar | −19° | — | 8° |
| | partially erupted 2nd molar | −14° | — | 10° |
| Lowers | anteriors | −6° | 0° | |
| (Maxillary) | cuspids | 0° | 3° | |
| | 1st bicuspid | −12° | 2° | |
| | 2nd bicuspid | −17° | 2° | |
| | 1st molar | −20° | — | 0° |
| | 2nd molar | −20° | — | 0° |
| | partially erupted 2nd molar | −10° | — | 0° |

### EXAMPLE 2

Roth Prescription

Roth

| Tooth | | torque | angulation | rotation |
|---|---|---|---|---|
| Uppers | central | 14° | 5° | |
| (Mandibular) | lateral | 7° | 8° | |
| | cuspid | −3° | 10° | |
| | 1st and 2nd bicuspids | −7° | 0° | |
| | 1st molar | TBD | — | TBD |
| | 2nd molar | TBD | — | TBD |
| | partially erupted 2nd molar | TBD | — | TBD |
| Lowers | anteriors | −1° | 0° | |
| (Maxillary) | cuspids | −7° | 6° | |
| | 1st bicuspid | −17° | 0° | |
| | 2nd bicuspid | −22° | 0° | |
| | 1st molar | TBD | — | TBD |
| | 2nd molar | TBD | — | TBD |
| | partially erupted 2nd molar | TBD | — | TBD |

### EXAMPLE 3

Bioprogressive Prescription

Bioprogressive (Hilgers)

| Tooth | | torque | angulation | rotation |
|---|---|---|---|---|
| Uppers | central | 22° | 5° | |
| (Mandibular) | lateral | 14° | 8° | |
| | cuspid | 7° | 10° | |
| | 1st and 2nd bicuspids | −7° | 0° | |
| | 1st molar | TBD | — | TBD |
| | 2nd molar | TBD | — | TBD |
| | partially erupted 2nd molar | TBD | — | TBD |
| Lowers | anteriors | −1° | 0° | |
| (Maxillary) | cuspids | 7° | 5° | |
| | 1st bicuspid | −11° | 0° | |
| | 2nd bicuspid | −17° | 0° | |
| | 1st molar | TBD | — | TBD |
| | 2nd molar | TBD | — | TBD |
| | partially erupted 2nd molar | TBD | — | TBD |

While the foregoing prescriptions may be similar to those found in bracket sets that have angled arch wire slots, it should be understood that the direction in which the engagement blocks are rotated or angled matches the desired movement of the teeth. By contrast, the angled slots in prescription brackets are angled in a direction that is opposite to the desired movement. In this way, the inventive orthodontic arch wires provide a more intuitive and meaningful prescription as compared to prescription brackets. In addition, they can be used with generic brackets that do not require intricate positioning procedures as compared to prescription brackets, which greatly simplifies bracket and wire installment and increases the likelihood of successful treatment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A low force orthodontic arch wire, comprising:
a core wire having shape memory, the core wire extending along a generally curved arch wire axis between a first end and a second end, the core wire having a first cross-sectional width;
a plurality of spaced-apart, bracket engagement blocks disposed along the core wire for placement into arch wire slots of corresponding orthodontic brackets, the engagement blocks having a second cross-sectional width that is greater than the first cross-sectional width of the core wire so as to provide increased engagement between the enlarged engagement block and an arch wire slot of a corresponding orthodontic bracket as compared to engagement that would otherwise be provided by the core wire within an arch wire slot if the engagement blocks were not present.

2. A low force orthodontic arch wire as recited in claim 1, wherein the core wire is substantially round in cross-section.

3. A low force orthodontic arch wire as recited in claim 1, wherein at least some of the engagement blocks are square or rectangular in cross-section so as to be capable of applying torquing forces to corresponding orthodontic brackets.

4. A low force orthodontic arch wire as recited in claim 3, wherein some of the engagement blocks are round in cross-section.

5. An orthodontic arch wire as recited in claim 1, wherein the core wire and the engagement blocks are formed of a shape-memory nickel-titanium alloy.

6. An orthodontic arch wire as recited in claim 1, wherein the core wire is a single, continuous strand of wire connecting the plurality of spaced-apart, bracket engagement blocks.

7. An orthodontic arch wire as recited in claim 1, wherein the core wire comprises more than one strand of wire extending between the first and second ends.

8. A low force orthodontic arch wire as recited in claim 1, wherein the engagement blocks are aligned relative to the core wire so that the engagement blocks have built-in prescription features so as to provide at least one corrective tooth movement selected from the group consisting of torque, rotation, and angulation;
wherein torque is provided when at least two of the engagement blocks have rectangular cross-sections and are angularly offset relative to each other along the arch wire axis;
wherein rotation is provided when at least one of the engagement blocks is rotated in a buccal-lingual direction relative to the arch wire axis; and
wherein angulation is provided when at least one of the engagement blocks is angled in a gingival-occlusal direction relative to the arch wire axis.

9. An orthodontic arch wire as recited in claim 8, wherein the orthodontic arch wire is configured to simultaneously provide at least two of torque, rotation, or angulation to a patient's teeth.

10. An orthodontic arch wire as recited in claim 8, wherein the orthodontic arch wire is configured to provide each of torque, rotation, and angulation to a patient's teeth.

11. An orthodontic arch wire as recited in claim 8, wherein the engagement blocks are configured to provide a prescribed set of torque values to teeth in a mandibular dental arch or a maxillary dental arch:
each tooth in the mandibular dental arch having a torque value in a range of:
5° to 25° for a central incisor;
3° to 14° for a lateral incisor;
0° to −10° for a cuspid;
−5° to −10° for a first or second bicuspid;
−5° to −15° for a first molar; and
−5° to −20° for a second molar; or
each tooth in the maxillary dental arch having a torque value in a range of:
0° to −10° for a central or lateral anterior;
−10° to 10° for a cuspid;
−10° to −20° for a first bicuspid;
−15° to −25 for a second bicuspid;
−15° to −25 for a first molar; and
−20° to −30° for a second molar.

12. An orthodontic arch wire as recited in claim 8, wherein the engagement blocks are configured to provide a prescribed set of angulation values to teeth in a mandibular dental arch or a maxillary dental arch:
each tooth in the mandibular dental arch having an angulation value in a range of:
3° to 10° for a central incisor;
4° to 12° for a lateral incisor;
4° to 12° for a cuspid;
0° to 5° for a first or second bicuspid;
0° to 10° for a first molar; and
0° to 10° for a second molar; or
each tooth in the maxillary dental arch having an angulation value in a range of:
0° to −10° for a central or lateral anterior;
2° to 8° for a cuspid;
0° to 5° for a first bicuspid;
0° to 5° for a second bicuspid;
0° to 5° for a first molar; and
0° to 5° for a second molar.

13. An orthodontic arch wire as recited in claim 8, wherein the engagement blocks are configured to provide a prescribed set of rotation values to teeth in a mandibular dental arch or a maxillary dental arch:
teeth in the mandibular dental arch having an rotation values in a range of:
5° to 15° for a first molar;
5° to 15° for a second molar; and
optionally including rotation values for a central incisor, a lateral incisor, a cuspid, or a first or second bicuspid; or
teeth in the maxillary dental arch having rotation values in a range of:
−5° to 5° for a first molar;
−5° to 5° for a second molar; and
optionally including rotation values for an anterior, a cuspid, a first bicuspid, or a second bicuspid.

14. An orthodontic treatment kit for providing one or more of torque, rotation or angulation to a patient's teeth, comprising
a low force orthodontic arch wire as recited in claim 1; and
a plurality of orthodontic brackets, each bracket comprising a bracket body with an arch wire slot formed in the bracket body, wherein each engagement block is configured to be received within the arch wire slot of a corresponding orthodontic bracket from among the plurality of brackets during use.

15. A kit as recited in claim 14, wherein the engagement blocks are aligned relative to the core wire so that the engagement blocks have built-in prescription features so as to provide at least one corrective tooth movement selected from the group consisting of torque, rotation, and angulation;
wherein torque is provided when at least two of the engagement blocks have rectangular cross-sections and are angularly offset relative to each other along the arch wire axis;
wherein rotation is provided when at least one of the engagement blocks is rotated in a buccal-lingual direction relative to the arch wire axis; and
wherein angulation is provided when at least one of the engagement blocks is angled in a gingival-occlusal direction relative to the arch wire axis.

16. A kit as recited in claim 15, wherein the arch wire including the engagement blocks is configured to provide at least a portion of a built-in prescription selected from the group consisting of an MBT prescription, a Roth prescription, a Bioprogressive/Hilgers prescription, and combinations thereof when used with zero angle brackets.

17. A kit as recited in claim 14, wherein the kit comprises more than one low force orthodontic arch wire, the low force orthodontic arch wires being of different stiffness.

18. A kit as recited in claim 17, wherein a first low force orthodontic arch wire is of a first gauge selected for an early stage of treatment and a second low force orthodontic arch wire is of a second gauge selected for a later stage of treatment.

19. A method of manufacturing a low force orthodontic arch wire, comprising:
providing a core wire having shape memory, the core wire extending along a generally curved arch wire axis between a first end and a second end, the core wire having a first cross-sectional width;
providing a plurality of bracket engagement blocks to be disposed along the core wire for placement into arch wire slots of corresponding orthodontic brackets, the engagement blocks having a second cross-sectional width that is greater than the first cross-sectional width of the core wire so as to provide increased engagement during use between the enlarged engagement block and an arch wire slot of a corresponding orthodontic bracket as compared to engagement that would otherwise be provided by the core wire within an arch wire slot if the engagement blocks were not present.

20. A method of manufacture as recited in claim 19, wherein the engagement blocks are initially separate from the core wire, the method further comprising attaching the engagement blocks to the core wire so that the plurality of engagement blocks are spaced apart from one another.

21. A method of manufacture as recited in claim 19, wherein the engagement blocks and the core wire are integrally molded as a single integral piece in a single molding step during manufacture.

22. A method of manufacture as recited in claim 19, wherein the engagement blocks are initially separate from the core wire, and are molded onto the core wire during manufacture.

23. A method of manufacture as recited in claim 19, wherein the engagement blocks are formed by removing material adjacent to the core wire during manufacture.

24. A method of manufacture as recited in claim 23, wherein adjacent material is removed by a machining or chemical etching process.

25. A method of orthodontic treatment using a low force orthodontic arch wire, the method comprising:
affixing a plurality of orthodontic brackets to at least one of a patient's mandibular or maxillary teeth, wherein each orthodontic bracket has an arch wire slot configured to receive a portion of an orthodontic arch wire; and
coupling a low force orthodontic arch wire as recited in claim 1 to the plurality of orthodontic brackets.
